(19) United States
(12) Patent Application Publication
(10) Pub. No.: US 2017/0125963 A1
(43) Pub. Date: May 4, 2017

(54) CABLE CRIMPING TOOL

(71) Applicant: ROY J. STONEBERGER, NOKESVILLE, VA (US)

(72) Inventor: ROY J. STONEBERGER, NOKESVILLE, VA (US)

(21) Appl. No.: 15/343,174

(22) Filed: Nov. 3, 2016

Related U.S. Application Data
(60) Provisional application No. 62/250,388, filed on Nov. 3, 2015.

(51) Int. Cl. H01R 43/042

(52) U.S. Cl. CPC H01R 43/042

(57) ABSTRACT

The cable crimping tool is a handheld, manually operated device resembling pliers. One jaw has two spaced apart, parallel plates. The opposite jaw has a single plate passing therebetween. A cable is placed across the opening between the jaws when the tool is opened. The cable is crimped or bent as the single plate jaw is pushed between the two opposing jaw plates when the handles are squeezed together. The tool is particularly useful in forming a series of bends or crimps in a cable to reduce the effective cable length. The reduction in effective cable length is useful in automatic garage door installations, where the bends or crimps draw the cable to a shorter length to take up slack if such occurs. This prevents the cable from slipping over the flange of the cable drum and the resulting work required to replace the cable on the drum.

### CROSS-REFERENCE TO RELATED APPLICATION

This application claims the benefit of U.S. Provisional Patent Application Ser. No. 62/250,388, filed Nov. 3, 2015.

### BACKGROUND OF THE INVENTION

1. Field of the Invention

The present invention relates generally to hand tools, and particularly to a cable crimping tool useful in forming one or more bends in a multi-strand cable to remove slack from a cable installation, as in an automatic garage door opening system.

2. Description of the Related Art

Flexible metal cables are used in innumerable environments to apply tension along a path or line. An example is seen in one type of conventional automatic garage door opening system, where two cables extend from rollers, drums, or reels to the lower corners of the garage door. The cables are normally under tension, and are secured about drums or rollers located at each end of a shaft that is, in turn, rotated by a torsion spring(s). Another cable, belt, chain, or jackscrew extends from a motor to the top of the garage door, and operates to draw the door open or to close the door on command. Most of the actual force is provided by the spring or springs acting upon the cables wound upon the drums or rollers.

The above-described system works well when all components are properly adjusted. However, if one of the cables becomes slack for some reason, the slack cable may become sufficiently loose to slip over the low flange at the edge or side of the cable drum. There is no conventional means of accommodating such slack in the cable. The result is an asymmetric pull on one side of the door, which will often cause the door to jam in place and/or damage the mechanism in some manner. While it is possible to reposition the slackened cable over the drum and to readjust the assembly for proper operation, this is not a trivial task. The preload on the opening spring(s) is quite high, and the forces resulting if the spring is suddenly released are potentially deadly to those who do not take proper safety precautions.

Thus, a cable crimping tool solving the aforementioned problems is desired.

### SUMMARY OF THE INVENTION

The cable crimping tool is a handheld manually operated device that operates using the principle of a pair of pliers, i.e., having a first member comprising a first handle and first jaw and a second member comprising a second handle and second jaw. The two members are joined to one another by a pivot pin installed at a point between the handles and jaws. The first jaw has a pair of spaced apart, parallel side plates defining a channel that is open at top and bottom. The second jaw comprises a single plate that passes between the plates of the first jaw when the two handles are pressed together. The spacing of the two plates of the first jaw is sufficient to allow not only the second jaw plate to pass therebetween, but also to allow for the thickness of a cable being bent between the two jaws. The three plates of the two jaws have smoothly rounded edges to preclude damage to a cable placed therebetween. Cable holding notches are formed in the plates, to prevent the cable from slipping from the jaws during the crimping operation.

The cable crimping tool can be used to crimp wire, multiple strand cable, or wire rope of any diameter that does not exceed the capacity of the tool. The tool is particularly useful in forming one or more crimps or bends in a multiple strand cable for installation in an automatic garage door mechanism. The bends or crimps serve to shorten the effective length of the cable in the event that tension is released on the cable. The reduction in the effective length of the cable removes, or at least greatly reduces, any slack that might otherwise form in the cable, thereby preventing the cable from slipping over the rim or flange of the cable drum upon which it is wound.

These and other features of the present invention will become readily apparent upon further review of the following specification and drawings.

### BRIEF DESCRIPTION OF THE DRAWINGS

FIG. 1 is a perspective view of a cable crimping tool according to the present invention, illustrating its general configuration with the jaws open.

FIG. 2A is a schematic partial environmental front elevation view of the cable crimping tool according to the present invention, showing a length of cable positioned across the open jaws.

FIG. 2B is a schematic partial environmental side elevation view of the cable crimping tool according to the present invention, shown in the configuration of FIG. 2A.

FIG. 3A is a schematic partial environmental front elevation view of the cable crimping tool according to the present invention, showing a length of cable gripped within the partially closed jaws.

FIG. 3B is a schematic partial environmental side elevation view of the cable crimping tool according to the present invention, shown in the configuration of FIG. 3A.

FIG. 4A is a schematic partial environmental front elevation view of the cable crimping tool according to the present invention, showing a length of cable crimped in the closed jaws.

FIG. 4B is a schematic partial environmental side elevation view of the cable crimping tool according to the present invention, shown in the configuration of FIG. 4A.

FIG. 5A is an elevation view of a length of cable having a single bend or crimp therein resulting from the use of the cable crimping tool according to the present invention.

FIG. 5B is an elevation view of a length of cable having a plurality of bends or crimps therein resulting from the use of the cable crimping tool according to the present invention.

Similar reference characters denote corresponding features consistently throughout the attached drawings.

### DETAILED DESCRIPTION OF THE PREFERRED EMBODIMENTS

The cable crimping tool is a handheld, manually operated device resembling a pair of pliers. The tool is particularly useful in forming one or more bends or crimps in a wire, multi-strand cable, or wire rope in order to reduce the effective length of the wire or cable. The cable is drawn straight when tension is applied thereto, but if the cable becomes slack, the bends or crimps cause the cable to resiliently draw up to shorten its effective length. This is particularly useful in cable installations in automatic garage door operating systems where cable slack might allow the cable to slip over the rim or flange of the cable drum, resulting in considerable work in order to reinstall the cable properly on the drum.

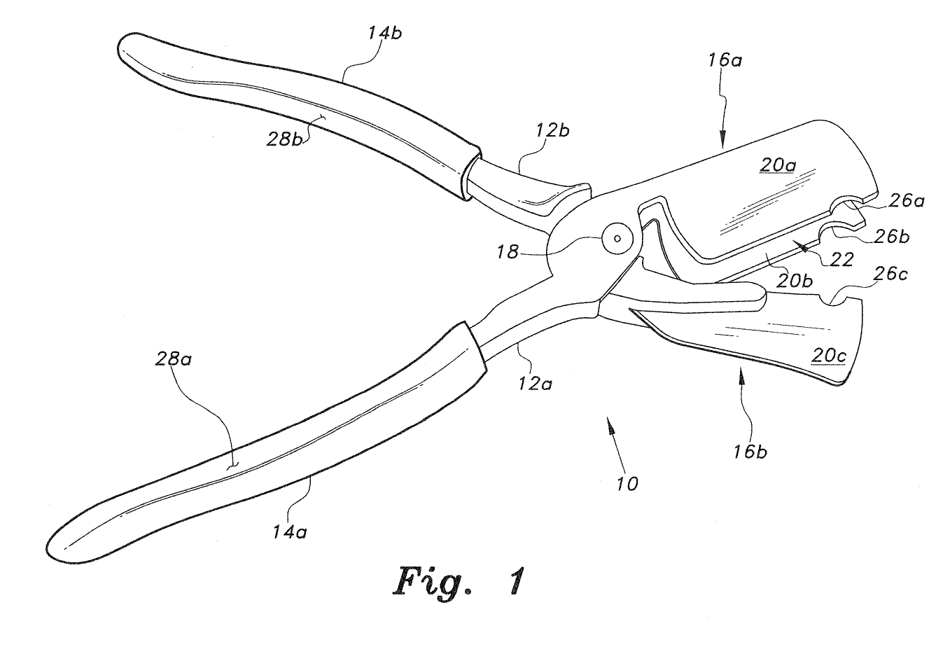

FIG. 1 of the drawings provides a perspective view of an exemplary cable crimping tool 10. The tool 10 includes a first member 12a and a second member 12b. The members 12a, 12b define first and second handles 14a and 14b and first and second jaws 16a and 16b, respectively. A pivot pin 18 passes through the fulcrums of the two members 12a and 12b between their handles 14a, 14b and jaws 16a, 16b to attach the two members pivotally to one another.

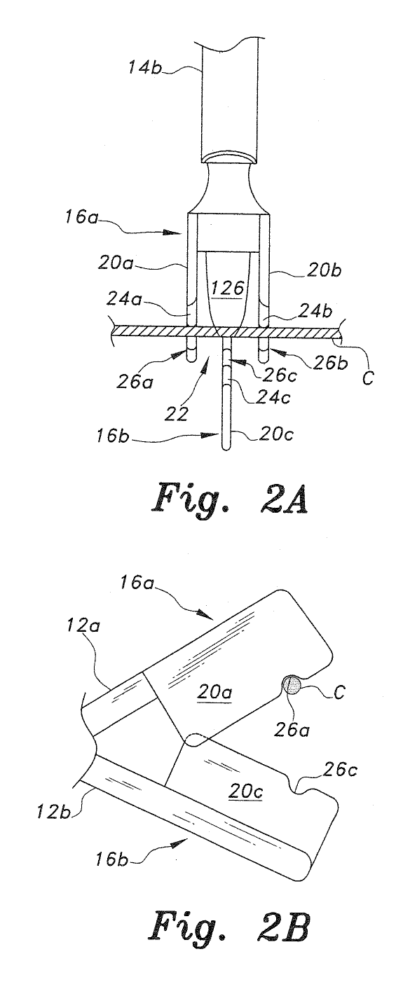

FIGS. 2A through 4B illustrate schematically the operation of the cable crimping tool 10. FIGS. 2A, 3A, and 4A are views from the front or jaw end of the tool 10, the handles extending to the rear in these drawings. FIGS. 2B, 3B, and 4B show the jaws of the tool from one side. In FIGS. 2A and 2B, the two jaws 16a and 16b are opened to permit the placement of a cable C laterally therein. The first jaw 16a comprises two parallel side plates 20a and 20b. The second jaw 16b comprises a single plate 20c parallel to the two first jaw plates 20a and 20b. The plates 20a through 20c may have rectangular shapes or configurations, as shown in the schematic illustrations of FIGS. 2B, 3B, and 4B, or some other regular or irregular shape, as exemplified in FIG. 1 of the drawings.

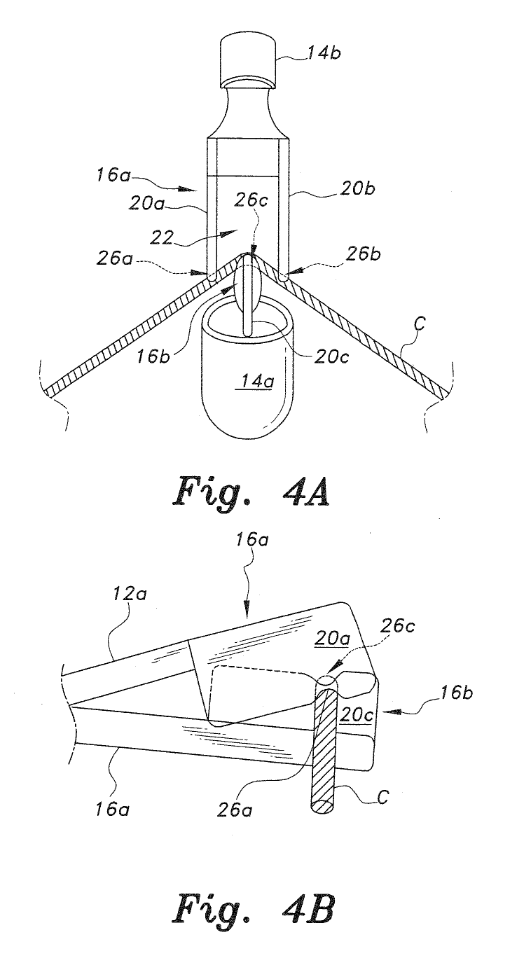

It will be seen in FIGS. 2A, 3A, and 4A that the two first jaw plates 20a and 20b are spaced apart laterally from one another and are open about their peripheries, except for their attachment to the first member 12a (FIG. 1), and define a channel 22 therebetween that is open at top and bottom. The lateral span of this channel 22 is sufficient to allow not only the second jaw plate 20c to pass therethrough when the jaws are closed, but also to allow for the diameter or thickness of the cable C to fit to either side of the second jaw plate 20c between the corresponding first jaw plates 20a and 20b. The second jaw plate 20c is centered relative to the longitudinal axis of the tool 10, and, thus, is centered between the two plates 20a, 20b of the first jaw 16a when the first and second jaws 16a, 16b are closed or partially closed, as seen in FIG. 4A.

The three jaw plates 20a through 20c each have inner edges, respectively 24a through 24c, i.e., those edges 24a and 24b of the first jaw plates 20a, 20b that generally face the corresponding edge 24c of the second jaw plate 20c. Each of these edges 24a through 24c is smoothly rounded or curved, as shown in FIGS. 2A, 3A, and 4A, in order to preclude nicking or otherwise damaging a cable C placed between the jaw plates 20a through 20c. The inner edges 24a through 24c of each of the jaw plates 20a through 20c also include first through third cable securing notches 26a through 26c. The cable securing notches 26a, 26b of the first jaw plates 20a, 20b are in registry with the third cable securing notch 26c of the second jaw plate 20c when the two jaws 16a, 16b are closed toward one another, i.e., all of the notches are the same distance from the fulcrum and pivot pin 18. The inner edges of these notches 26a through 26c are also smoothly contoured and rounded, similar to the inner edges 24a through 24c of the jaw plates 20a through 20c.

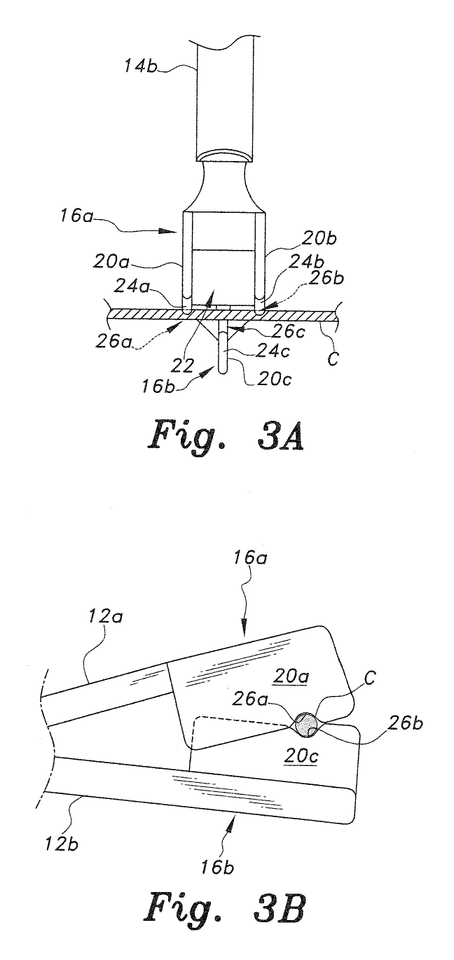

The cable crimping tool 10 is used by first spreading the two handles 14a, 14b to open the corresponding jaws 16a, 16b and the jaw plates 20a, 20b, and 20c. This allows a cable C to be placed across the jaw plates 20a, 20b and nested in the cable securing notches 26a, 26b. The cable C might initially be placed across the two first jaw plate notches 20a, 20b with the desired location for the bend or crimp centered between the two first jaw plate notches, generally as shown in FIGS. 2A and 2B, the two handles 14a, 14b then being partially closed to grip the cable C in the two first jaw plate notches 26a and 26b by the second jaw plate notch 26c, as shown in FIGS. 3A and 3B. Pressure is then applied to the two handles 14a, 14b to close them toward one another, thus moving the second jaw plate 20c between the two first jaw plates 20a and 20b and bending or crimping the cable C therebetween, generally as shown in FIGS. 4A and 4B. Considerable force may be required on the two handles 14a, 14b, depending upon the diameter or thickness of the cable C being crimped or bent. Accordingly, resilient handgrips 28a, 28b may be applied to the two handles 14a, 14b, as shown in FIG. 1, to provide a better grip and greater comfort for the user of the tool 10.

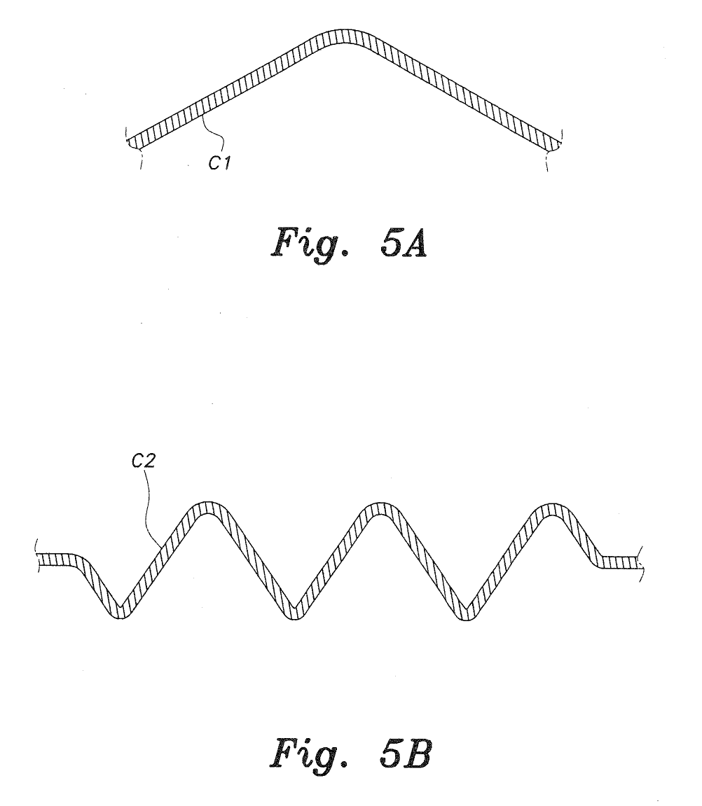

When the desired degree or amount of bend or crimp has been formed in the cable C, the two handles 14a, 14b are moved apart to open the two jaws 16a, 16b and the jaw plates 20a through 20c, thereby allowing the crimped cable C to be removed. The resulting crimped cable C is shown in FIG. 5A. The process may be repeated as many times as desired or required by repositioning the crimped cable C1 with a different part of the cable positioned between the jaw plates 20a through 20c, resulting in a cable C2 with a plurality of crimps or bends therein as shown in FIG. 5B.

It is to be understood that the present invention is not limited to the embodiments described above, but encompasses any and all embodiments within the scope of the following claims.

I claim:

1. A cable crimping tool, comprising:
a first member, the first member having a first handle and a first jaw opposite the first handle;
a second member, the second member having a second handle and a second jaw opposite the second handle;
a pivot pin passing through the first and second members, the pivot pin pivotally securing the first and second members to one another; and
the first jaw defining an open second jaw and cable passage therebetween.

2. The cable crimping tool according to claim 1, further comprising:
the first jaw comprising laterally separated, parallel first and second plates, the plates defining an open second jaw and cable passage therebetween; and
the second jaw comprising a single plate, the single plate of the second jaw being parallel to and centered between the first and second plates of the first jaw when the first and second jaws are closed.

3. The cable crimping tool according to claim 2, further comprising:
first and second cable securing notches disposed in the respective first and second plates of the first jaw; and
a third cable securing notch disposed in the plate of the second jaw, the first, second, and third cable securing notches being in registry with one another when the first and second jaws are closed toward one another.

4. The cable crimping tool according to claim 2, wherein the first and second plates of the first jaw have smoothly rounded inner edges and the single plate of the second jaw has a smoothly rounded inner edge, the inner edges of the plates of the first jaw generally facing the inner edge of the plate of the second jaw when the jaws are opened.

5. The cable crimping tool according to claim 2, further comprising:
the first and second plates of the first jaw and the single plate of the second jaw each having a generally rectangular configuration; and
the first handle and the second handle each having a resilient handgrip thereon.

6. A method of crimping a cable using the crimping tool according to claim 1, comprising the steps of:
(a) spreading the first and second handles away from one another, thereby opening the first and second jaws relative to one another;
(b) inserting a cable laterally between the first jaw and the second jaw;
(c) closing the first and second handles toward one another, thereby forcing the second jaw and the cable between the second jaw and cable passage of the first jaw, crimping the cable between the first jaw and the second jaw;
(d) spreading the first and second handles from one another, thereby opening the first and second jaws relative to one another; and
(e) removing the crimped cable from between the first jaw and the second jaw.

7. The method of crimping a cable according to the method of claim 6, wherein the steps (b) through (f) are repeated in sequence, thereby forming a plurality of crimps in the cable.

8. A cable crimping tool, comprising:
a first member, the first member having a first handle and a first jaw opposite the first handle;
a second member, the second member having a second handle and a second jaw opposite the second handle;
a pivot pin passing through the first and second members, the pivot pin pivotally securing the first and second members to one another;
the first jaw comprising laterally separated, parallel first and second plates; and
the second jaw comprising a single plate, the single plate of the second jaw being parallel to and centered between the first and second plates of the first jaw when the first and second jaws are closed.

9. The cable crimping tool according to claim 8, further comprising the first and second plates of the first jaw defining an open second jaw and cable passage therebetween.

10. The cable crimping tool according to claim 8, further comprising:
first and second cable securing notches disposed in the respective first and second plates of the first jaw; and
a third cable securing notch disposed in the plate of the second jaw, the first, second, and third cable securing notches being in registry with one another when the first and second jaws are closed toward one another.

11. The cable crimping tool according to claim 8, wherein the first and second plates of the first jaw have smoothly rounded inner edges; and
the single plate of the second jaw has a smoothly rounded inner edge, the inner edges of the plates of the first jaw facing the inner edge of the plate of the second jaw when the jaws are opened.

12. The cable crimping tool according to claim 8, further comprising:
the first and second plates of the first jaw and the single plate of the second jaw each having a generally rectangular configuration; and
the first handle and the second handle each having a resilient handgrip thereon.

13. A method of crimping a cable using the crimping tool according to claim 8, comprising the steps of:
(a) spreading the first and second handles from one another, thereby opening the first and second jaws relative to one another;
(b) inserting a cable laterally between the first jaw and the second jaw;
(c) closing the first and second handles toward one another, thereby forcing the second jaw and the cable between the second jaw and cable passage of the first jaw, crimping the cable between the first jaw and the second jaw;
(d) spreading the first and second handles from one another, thereby opening the first and second jaws relative to one another; and
(e) removing the crimped cable from between the first jaw and the second jaw.

14. The method of crimping a cable according to the method of claim 13, wherein the steps (b) through (f) are repeated in sequence, thereby forming a plurality of crimps in the cable.

15. A method of crimping a cable, comprising the steps of:
(a) providing a cable crimping tool, the tool having a first member, the first member having a first handle and a first jaw opposite the first handle, the tool further having a second member, the second member having a second handle and a second jaw opposite the second handle, the tool further having a pivot pin passing through the first and second members, the pivot pin pivotally securing the first and second members to one another;
(b) spreading the first and second handles from one another, thereby opening the first and second jaws relative to one another;
(c) inserting a cable laterally between the first jaw and the second jaw;
(d) closing the first and second handles toward one another, thereby forcing the second jaw and the cable between the second jaw and cable passage of the first jaw, crimping the cable between the first jaw and the second jaw;
(e) spreading the first and second handles from one another, thereby opening the first and second jaws relative to one another; and
(f) removing the crimped cable from between the first jaw and the second jaw.

16. The method of crimping a cable according to the method of claim 15, wherein the steps (b) through (f) are repeated in sequence, thereby forming a plurality of crimps in the cable.
